(19) United States
(12) Patent Application Publication
(10) Pub. No.: US 2022/0111507 A1
(43) Pub. Date: Apr. 14, 2022

(54) TOOL HANDLE COUPLING ASSEMBLY

(71) Applicant: The Ames Companies, Inc., Camp Hill, PA (US)

(72) Inventors: Joshua O. MULLEN, Duncannon, PA (US); Thomas McMAHON, Celebration, FL (US)

(21) Appl. No.: 17/488,718

(22) Filed: Sep. 29, 2021

Related U.S. Application Data
(60) Provisional application No. 63/089,091, filed on Oct. 8, 2020.

(51) Int. Cl. B25G 3/30; B25G 1/10; B25G 1/04

(52) U.S. Cl. CPC B25G 3/30; B25G 1/04; B25G 1/102

(57) ABSTRACT

A tool handle coupling assembly is provided with a coupler with an opposed pair of receptacles. A pair of bushings are each sized to receive a portion of a handle therein and are each sized to be installed into one of the pair of receptacles.

### CROSS-REFERENCE TO RELATED APPLICATIONS

This application claims the benefit of U.S. provisional application Ser. No. 63/089,091 filed Oct. 8, 2020, the disclosure of which is hereby incorporated in its entirety by reference herein.

### TECHNICAL FIELD

Various embodiments relate to the coupling assemblies for tool handles.

### BACKGROUND

The prior art provides connectors and couplers for tool handles.

### SUMMARY

According to an embodiment, a tool handle coupling assembly is provided with a coupler with an opposed pair of receptacles. A pair of bushings are each sized to receive a portion of a handle therein, and are each sized to be installed into one of the pair of receptacles.

According to a further embodiment, a grip sleeve is oriented over the coupler.

According to another further embodiment, each of the pair of bushings is provided with a bushing receptacle.

According to another further embodiment, the coupler is symmetrical so that the pair of bushings may each be installed into either coupler receptacle. The pair of bushings are identical for installation into either coupling receptacle.

According to another further embodiment, the coupler is formed with a hollow cavity with a pair of openings to provide the pair of receptacles.

According to an even further embodiment, the coupler includes a lengthwise series of indentations formed along a length within the coupler.

According to yet an even further embodiment, a slot is formed in each bushing in a length direction in a body of the bushing sized to align with the series of indentations in the corresponding coupler to prevent rotation of the bushing relative to the coupler.

According to another even further embodiment, the coupler is further provided with a radial array of projections with a leading edge inclined away from the corresponding opening and an abutment edge facing away from the corresponding opening to engage a body of the corresponding bushing such that installation of the bushing elastically deforms the radial array of projections, and the abutment edges engage the body of the bushing under compression to prevent removal of the bushing from the coupler.

According to another even further embodiment, each bushing is further provided with an array of external projections that are sized to be received within the coupler cavity.

According to an even further embodiment, the array of external projections is oversized relative to the coupler cavity to provide an interference fit within the coupler cavity.

According to another further embodiment, each bushing is formed with a hollow body to form a cavity, with an opening at one end to provide a receptacle, a collar formed about the opening, and an enclosed bottom end of the body.

According an even further embodiment, each bushing is further provided with an array of inner projections within the cavity to engage the portion of the corresponding handle.

According to another even further embodiment, each bushing is further provided with at least one contact pad upon the bottom end of the body to provide an axial limit to an installation of the handle portion into the bushing cavity.

According to another even further embodiment, each bushing is further provided with a lock projection extending outward from the bushing body along a partial length of the body and extending from the collar to plastically deform during installation into a coupler cavity to lock the bushing within the coupler.

According to another even further embodiment, an undercut is formed underneath the collar of each bushing to provide an axial limit for a depth of installation of the bushing into the coupler.

According to another embodiment, a tool handle assembly is provided with a tool handle coupling assembly with a coupler with an opposed pair of receptacles. A pair of bushings are each sized to receive a portion of a handle therein, and are each sized to be installed into one of the pair of receptacles. Each of the pair of bushings is provided with a bushing receptacle. A pair of handle portions are each sized to be received within one of the bushing receptacles.

According to a further embodiment, each of the pair of handle portions are sized to provide an interference fit within the bushing receptacles.

According to another further embodiment, a tool connector is provided on one of the pair of handle portions to connect to a head of a tool.

According to another embodiment, a tool handle assembly is provided with a coupler with an opposed pair of coupler receptacles. A grip sleeve is oriented over the coupler. A pair of bushings are each provided with a bushing receptacle, and each is sized to be installed into one of the pair of coupler receptacles. A pair of handle portions are each sized to be received within one of the bushing receptacles.

According to another embodiment, a method for retailing a tool assembly provides a first handle portion and a second handle portion that are each less than three feet long with a bushing at one end of each handle portion. A coupler is provided that is sized to receive and connect the bushings of the first and second handle portions. The disassembled first handle portion, second handle portion and coupler are packaged for retail.

### BRIEF DESCRIPTION OF THE DRAWINGS

FIG. 1 is a perspective view of a tool handle assembly with a tool handle coupling assembly according to an embodiment;

FIG. 2 is a partially exploded perspective view of the tool handle assembly of FIG. 1;

FIG. 3 is a lengthwise elevation view of a coupler of the tool handle coupling assembly of the tool handle assembly of FIG. 1;

FIG. 4 is a section view of the coupler taken along section line 4-4 in FIG. 3;

FIG. 5 is an axial end view of the coupler of FIG. 3;

FIG. 6 is a lengthwise elevation view of a bushing of the tool handle coupling assembly of the tool handle assembly of FIG. 1;

FIG. 7 is a section view of the bushing taken along section line 7-7 in FIG. 6;

FIG. 8 is an axial end view of the bushing of FIG. 6;

FIG. 9 is a section view of the bushing taken along section line 9-9 in FIG. 7;

FIG. 10 is an enlarged view of a portion of the bushing labeled 10 in FIG. 8; and

FIG. 11 is an enlarged partial section view of a portion of the bushing labeled 11 in FIG. 7.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Consumers are often willing to order consumer goods instead of purchasing the consumer goods at a retailer for convenience of eliminating travel to a retailer. Often the consumer goods are ordered online, via purchasing over the internet. Overhead costs of online sales can be reduced in comparison to a retail purchase by eliminating the retailer. However, additional shipping costs are incurred from ordered purchases. Shipping costs are often a direct result of weight and overall size or volume.

Certain consumer goods have a significant overall size, such as garden and home tools with elongate handles, including brooms, shovels, hoes, rakes, yard forks, post-hole diggers, scrapers, scoops, tampers, weed cutters, edgers, squeegees, scrub brushes, and other long handle tools. Disconnecting a tool handle from the tool slightly reduces the overall packaging of the tool.

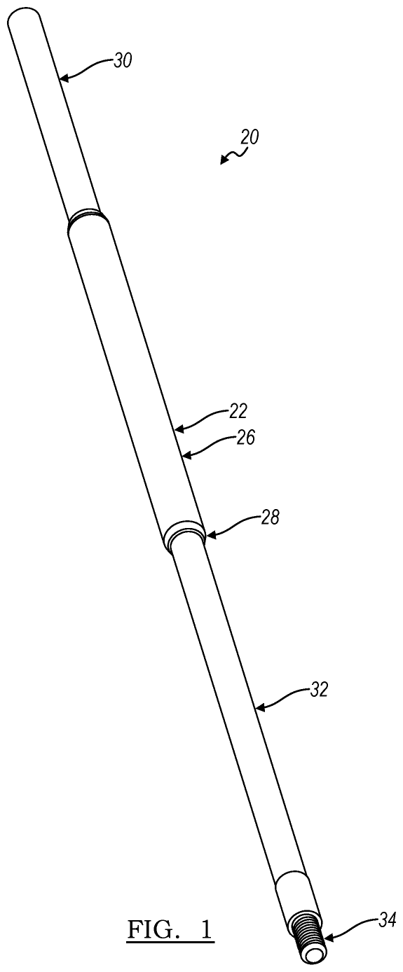

FIG. 1 illustrates a tool handle assembly 20 according to an embodiment. The tool handle assembly 20 has a significant overall length, such as over two feet, or over three feet for utilization with a variety of garden and home tools that employ an elongate handle. The tool handle assembly 20 is provided from a plurality of individual components to reduce an overall packaging size for the tool handle assembly 20, and consequently the associated tool. The overall packaging reduction consequently reduces the shipping costs of the tool. The individual components can be manually assembled by the end consumer. The tool handle assembly 20 provides a structural integrity of the tool handle assembly 20 comparable to a single component handle.

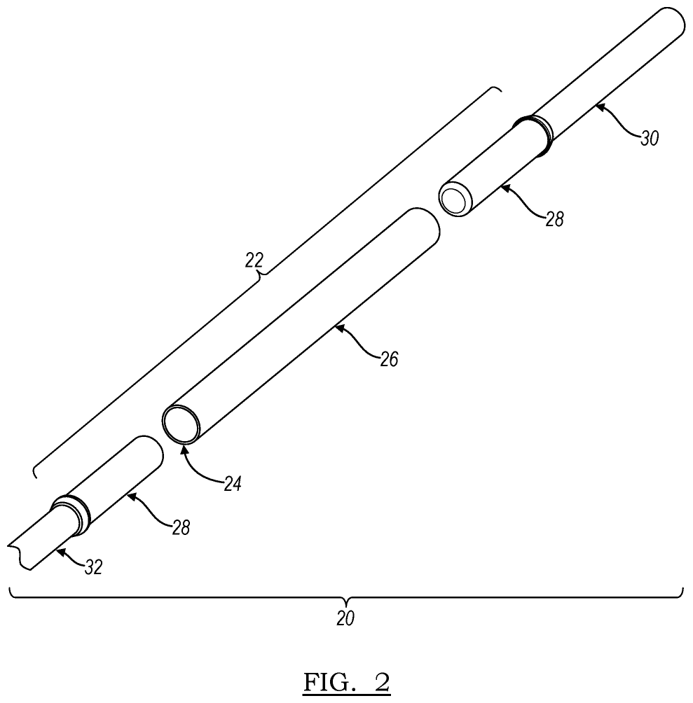

FIG. 2 illustrates the tool handle assembly 20 partially exploded to illustrate the tool handle assembly 20 during assembly by the end consumer. Referring to FIGS. 1 and 2, the tool handle assembly 20 includes a tool handle coupling assembly 22 for interconnecting the tool handle assembly 20. The tool handle coupling assembly 22 includes a coupler 24, which is concealed in FIG. 1 and exposed in FIG. 2. According to an embodiment a grip sleeve 26 is disposed over the coupler 24 to provide a grip surface to the consumer. The coupler 24 may be symmetrical so that either lengthwise orientation of the coupler 24 is suitable for assembling the tool handle coupling assembly 22 to eliminate errors in assembly.

The tool handle coupling assembly 22 also includes a pair of bushings 28 that are each sized to be installed into an end of the coupler 24. The tool handle assembly 20 also includes a distal handle portion 30 and a proximal handle portion 32. The distal handle portion 30 is installed into one of the bushings 28, which is then installed into the coupler 24. The proximal handle portion 32 is installed into the other bushing 28, and then installed into the coupler 24. The bushings 28 may be identical to simplify the assembly process for the consumer, and to avoid improper assembly.

Referring again to FIG. 1, the tool handle assembly 20 also includes a tool connector 34 on the proximal handle portion 32 to connect the proximal handle portion 32, and consequently the tool handle assembly 20 to the head of a tool.

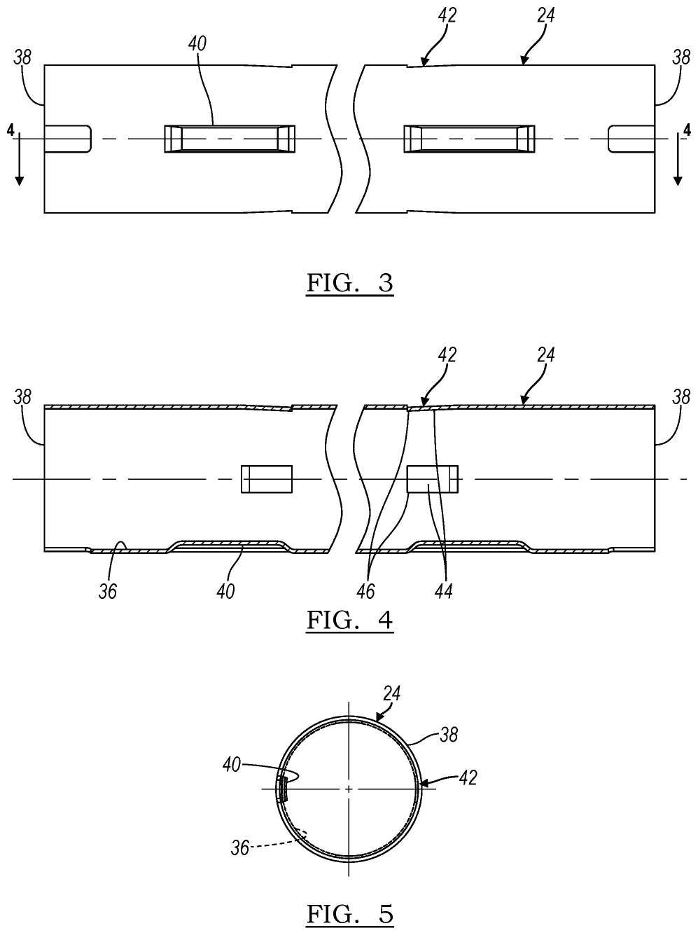

FIGS. 3-5 illustrate the coupler 24 in greater detail. The coupler 24 is generally cylindrical. The coupler may be formed with a round cross section, as illustrated in FIG. 5. The coupler 24 is formed from a structurally resilient material, such as steel according to an embodiment. The coupler 24 may be formed from a sheet steel material. The coupler 24 is formed with a hollow cavity 36 with a pair of openings 38. Each opening 38 provides access to cavity 36 so that each end of the coupler 24 provides a receptacle for receiving one of the bushings 28.

The coupler 24 includes a lengthwise series of indentations 40 formed along the length of the coupler 24. The indentations 40 extend into the cavity 36 and are aligned longitudinally to provide an angular locator within the coupler 24. The coupler 24 also includes a radial array or projections 42. As illustrated in FIG. 4, each of the projections has a leading edge 44 inclined away from the corresponding cavity 36, and an abutment edge 46 facing away from the corresponding cavity 36.

With reference again to FIGS. 1 and 2, the grip sleeve 26 may be formed from a polymeric material, such as a flexible polyvinyl-chloride, or the like. The grip sleeve 26 may sized to receive the coupler within the sleeve 26, such as by an interference fit, fasteners, or the like. The grip sleeve 26 provides a flexible and comfortable grip surface that is more suitable for manual grasping than the metal coupler 24.

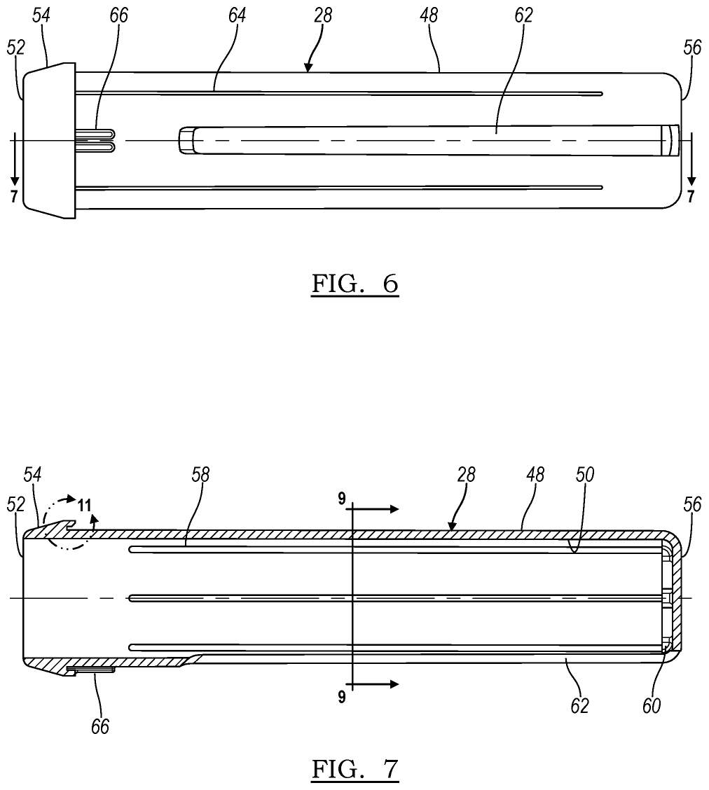

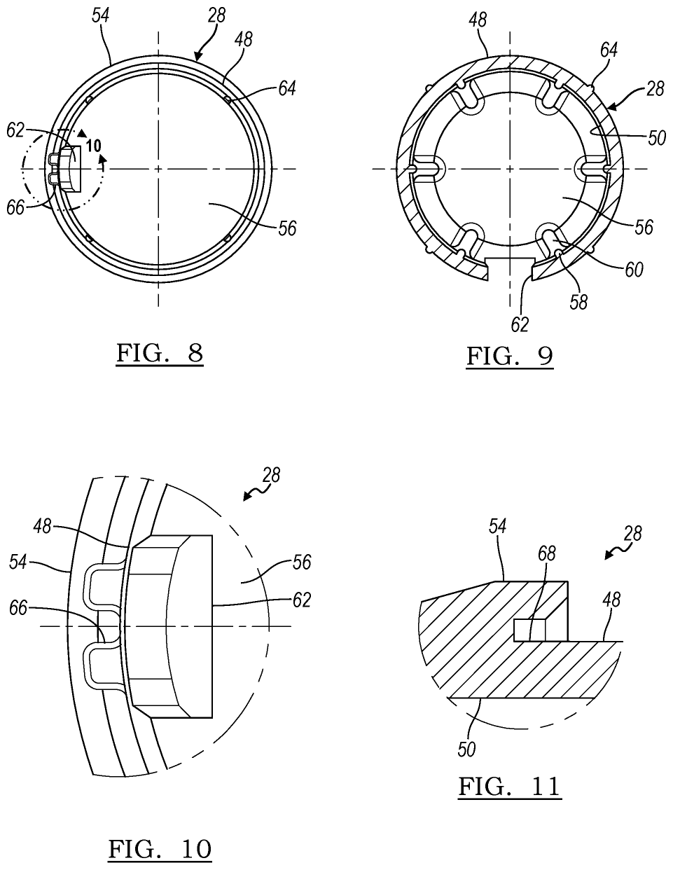

FIGS. 6-11 illustrate the bushings 28 in greater detail. The bushings 28 are identical so that one design can be employed for both receptacles of the coupler 24. Each bushing 28 includes a hollow body 48 to form a cavity 50 within the bushing 28. The bushing includes an opening 52 at one end to provide a receptacle for access to the cavity 50. A collar 54 is formed about the opening 52. A proximal end of the bushing 28 is enclosed with a bottom end 56 of the body 48 to provide a blind depth to the cavity 50.

The bushings 28 may be formed from a suitable structural polymer, such as a polypropylene homopolymer, or the like. The body 48 and the cavity 50 may include a draft that decreases from the opening 52 to the bottom end 56 to facilitate removal of the bushing 28 from an injection molding machine or the like.

The bushing 28 includes an array of inner ribs 58. The ribs 58 are sized to extend into the cavity 50 and engage the handle portion 30, 32 received within the cavity 50 and to provide a designed contact area between the handle portion 30, 32 and the bushing 28. The ribs 58 may also be sized to provide an interference fit with the handle portion 30, 32 received within the cavity 50. A plurality of contact pads 60 extend upon the bottom end 56 to provide an axial limit to the installation of the handle portion 30, 32 into the bushing 28 to positively locate a depth of the handle portion 30, 32 into the cavity 50.

The bushing 28 includes a slot 62 formed in a length direction in the body 48. The slot 62 is sized to align with the indentations 40 in the coupler 24. The slot 62 and the indentations 40 cooperate to prevent rotation of the bushing 28 relative to the coupler 24 to provide a secure coupling between the bushings 28 and the coupler 24 that is free from unwanted twisting.

The bushing 28 also includes an array of outer ribs 64 that are sized to be received within the cavity 50 and to manage a contact surface area between the bushing 28 and the coupler 24. The outer ribs 64 may be oversized relative to the cavity 50 to provide an interference fit of the bushing 28 within the coupler 24.

Referring again to FIGS. 3-5, the projections 42 of the coupler 24 are sized to engage the body 48 of the bushing 28 as the bushing 28 is installed in the coupler 24. For example, as the body 48 is inserted into the cavity 36 of the coupler 24, the body 48 contacts the leading edges 44 of the projections 42 thereby elastically deforming the projections 42. The abutment edges 46 of the projections 42 engage the body 48 under compression to prevent removal of the bushing 28 from the coupler 24. Additionally, draft angles of the body 48 and the cavity 50 of the bushing 28 may be designed to progressively increase compression upon the bushing 28, and consequently increase compression upon the handle portion 30, 32.

FIGS. 6-8 and 10 illustrate a pair of locking projections 66 extending outward from the body 48 of the bushing 26 a partial length of the bushing 28 and extending from the collar 54. The locking projections 66 may be designed to plastically deform within the coupler 24 to lock the bushing 28 within the coupler 24. FIG. 11 illustrates that an undercut 68 may be formed underneath the collar 54. The undercut 68 is sized to partially receive the coupler 24. The undercut 68 is also designed to provide an axial limit for a depth of installation of the body 48 of the bushing 28 into the coupler 24.

The tool handle assembly 20 provides a compact handle assembly 20 that may be shipped to the consumer partially disassembled. The assembly process is sufficiently simple that the end consumer can assemble the tool handle assembly 20 without additional tools. The bushings 28 may be preinstalled upon the handle portions 30, 32 for compactness in shipping. Otherwise, the end user may install each of the handle portions 30, 32 into one of the pair of bushings 28. Subsequently, the end user aligns each bushing 28 with the coupler 24 as illustrated in FIG. 2, and then presses each handle portion 30, 32 and the corresponding bushings 28 into the coupler 24. Finally, the end user may press the assembled tool handle assembly 20 axially to ensure that both of the bushings 28 are fully seated within the coupler 24.

The tool handle coupling assembly 22 provides a rigid and secure connection to the assembled tool handle assembly 20 that provides the structural integrity associated with unitary tool handles, while also providing an enhanced grip surface of the grip sleeve 26. The tool handle assembly 20 may be sold and shipped directly to the consumer, with or without a tool head, for the convenience of the consumer.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A tool handle coupling assembly comprising:
a coupler with an opposed pair of receptacles; and
a pair of bushings, each sized to receive a portion of a handle therein, and each sized to be installed into one of the pair of receptacles.

2. The tool handle coupling assembly of claim 1 further comprising a grip sleeve oriented over the coupler.

3. The tool handle coupling assembly of claim 1 wherein each of the pair of bushings is provided with a bushing receptacle.

4. A tool handle assembly comprising:
the tool handle coupling assembly of claim 3; and
a pair of handle portions, each sized to be received within one of the bushing receptacles.

5. The tool handle assembly of claim 4 wherein each of the pair of handle portions are sized to provide an interference fit within the bushing receptacles.

6. The tool handle assembly of claim 4 further comprising a tool connector on one of the pair of handle portions to connect to a head of a tool.

7. The tool handle coupling assembly of claim 1 wherein the coupler is symmetrical so that the pair of bushings may each be installed into either coupler receptacle; and
wherein the pair of bushings are identical for installation into either coupling receptacle.

8. The tool handle coupling assembly of claim 1 wherein the coupler is formed with a hollow cavity with a pair of openings to provide the pair of receptacles.

9. The tool handle coupling assembly of claim 8 wherein the coupler includes a lengthwise series of indentations formed along a length within the coupler.

10. The tool handle coupling assembly of claim 9 wherein a slot is formed in each bushing in a length direction in a body of the bushing sized to align with the series of indentations in the corresponding coupler to prevent rotation of the bushing relative to the coupler.

11. The tool handle coupling assembly of claim 8 wherein the coupler further comprises a radial array of projections with a leading edge inclined away from the corresponding opening and an abutment edge facing away from the corresponding opening to engage a body of the corresponding bushing such that installation of the bushing elastically deforms the radial array of projections, and the abutment edges engage the body of the bushing under compression to prevent removal of the bushing from the coupler.

12. The tool handle coupling assembly of claim 8 wherein each bushing further comprises an array of external projections that are sized to be received within the coupler cavity.

13. The tool handle coupling assembly of claim 12 wherein the array of external projections is oversized relative to the coupler cavity to provide an interference fit within the coupler cavity.

14. The tool handle coupling assembly of claim 1 wherein each bushing is formed with a hollow body to form a cavity, with an opening at one end to provide a receptacle, a collar formed about the opening, and an enclosed bottom end of the body.

15. The tool handle coupling assembly of claim 14 wherein each bushing further comprises an array of inner projections within the cavity to engage the portion of the corresponding handle.

16. The tool handle coupling assembly of claim 14 wherein each bushing further comprises at least one contact pad upon the bottom end of the body to provide an axial limit to an installation of the handle portion into the bushing cavity.

17. The tool handle coupling assembly of claim 14 wherein each bushing further comprises a lock projection extending outward from the bushing body along a partial length of the body and extending from the collar to plastically deform during installation into a coupler cavity to lock the bushing within the coupler.

18. The tool handle coupling assembly of claim 14 wherein an undercut is formed underneath the collar of each bushing to provide an axial limit for a depth of installation of the bushing into the coupler.

19. A tool handle assembly comprising:
a coupler with an opposed pair of coupler receptacles;
a grip sleeve oriented over the coupler;
a pair of bushings, each with a bushing receptacle, and each sized to be installed into one of the pair of coupler receptacles; and
a pair of handle portions, each sized to be received within one of the bushing receptacles.

20. A method for retailing a tool assembly comprising:
providing a first handle portion and a second handle portion that are each less than three feet long with a bushing at one end of each handle portion;
providing a coupler sized to receive and connect the bushings of the first and second handle portions; and
packaging the disassembled first handle portion, second handle portion and coupler for retail.
